(19) United States
(12) Patent Application Publication
(10) Pub. No.: US 2015/0294257 A1
(43) Pub. Date: Oct. 15, 2015

(54) Techniques for Reducing Employee Churn Rate

(71) Applicant: Abbas Raza, Union City, CA (US)

(72) Inventor: Abbas Raza, Union City, CA (US)

(73) Assignee: SuccessFactors, Inc., South San Francisco, CA (US)

(21) Appl. No.: 14/251,370

(22) Filed: Apr. 11, 2014

(51) Int. Cl. G06Q 10/06

(52) U.S. Cl. CPC G06Q 10/06398

(57) ABSTRACT

A system is described for reducing employee churn rate in an organization. The system generates a baseline model that represents the satisfaction of employees in the company based on a multiple employee metrics. Employee values are then generated for a selected employee according to employee data collected on the employee. The baseline model is applied to the employee values to generate an overall employee satisfaction score. Depending on the score, a determination is made as to the likelihood that the employee will leave the organization. Corrective actions to improve the employee satisfaction score can optionally be generated.

### BACKGROUND

Employees are the most valuable resource in any company. This is particularly true in the technology sector where an engineer's specific expertise can play an important role in the company's success. For example, an employee can develop a knowledge base related to a product or service offered by the company over time and become a specialist. As a specialist, the employee is extremely qualified to fix issues or make improvements to that product or service, thus making the employee difficult to replace. In some scenarios, a company can spend 150% of a departed employee's salary to bring a new hire to the level of proficiency as the departed employee.

Employee churn rate is a measure of employee attrition and is defined as the number of employees who leave a company during a specified period of time divided by the total number of employees employed at the company over that same time period. As described above, replacing an employee can be a very expensive. As a result, companies often do their best to reduce the employee churn rate. However, this is typically a guessing game since it is difficult to determine exactly why an employee leaves. For example, an employee can leave because of personality conflicts with a manager, lack of interesting assignments, or inadequate compensation. Even if the company discovers the issue, it often is already too late to correct the issue.

### SUMMARY

In one embodiment, a computer-implemented method receives, by a processor, a request to perform churn analysis on an employee within the organization. The method then determines, by the processor, that the employee of the organization is associated with a role in the organization. The method then derives, by the processor, an employee value from employee data generated by a plurality of enterprise applications utilized by the organization, the employee value being for an employee metric that describes an attribute of the employee. The method then generates, by the processor, a satisfaction score for the employee from a baseline model corresponding to the organization and the employee value, wherein the baseline model includes a baseline corresponding to the employee metric and the role in the organization.

In another embodiment, a non-transitory computer readable storage medium stores one or more programs comprising instructions for receiving a request to perform churn analysis on an employee within the organization, determining that the employee of the organization is associated with a role in the organization, deriving an employee value from employee data generated by a plurality of enterprise applications utilized by the organization, the employee value being for an employee metric that describes an attribute of the employee; and generating a satisfaction score for the employee from a baseline model corresponding to the organization and the employee value, wherein the baseline model includes a baseline corresponding to the employee metric and the role in the organization.

In another embodiment, a computer implemented system comprises one or more computer processors and a non-transitory computer-readable storage medium. The non-transitory computer-readable storage medium comprises instructions, that when executed, control the one or more computer processors to be configured for receiving a request to perform churn analysis on an employee within the organization, determining that the employee of the organization is associated with a role in the organization, deriving an employee value from employee data generated by a plurality of enterprise applications utilized by the organization, the employee value being for an employee metric that describes an attribute of the employee; and generating a satisfaction score for the employee from a baseline model corresponding to the organization and the employee value, wherein the baseline model includes a baseline corresponding to the employee metric and the role in the organization.

The following detailed description and accompanying drawings provide a better understanding of the nature and advantages of the present disclosure.

### BRIEF DESCRIPTION OF THE DRAWINGS

FIG. 1 illustrates a system according to one embodiment;

FIG. 2 illustrates organization data according to one embodiment;

FIG. 3 illustrates a baseline model according to one embodiment;

FIG. 4 illustrates three exemplary baselines according to one embodiment;

FIG. 5 illustrates a system for analyzing employee churn according to one embodiment;

FIG. 6 illustrates a process flow for generating a baseline model according to one embodiment;

FIG. 7 illustrates a process flow for generating analyzing employee churn according to one embodiment; and

FIG. 8 illustrates an exemplary computer system according to one embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

Various embodiments described herein enable an organization to identify a disgruntled employee within the organization that may potentially leave the organization. Furthermore, recommendations can be provided to help alleviate the employee's discontent. This can prevent the employee from leaving the organization, thus reducing employee churn rate. The techniques described can be used to generate a baseline model that represents the organization and apply the baseline model to a particular employee to determine whether the employee is likely to leave the organization. In some embodiments, company resources can also be examined to determine whether a remedial action exists to reduce the employee's discontent, thus improving the chances that the employee will stay with the organization.

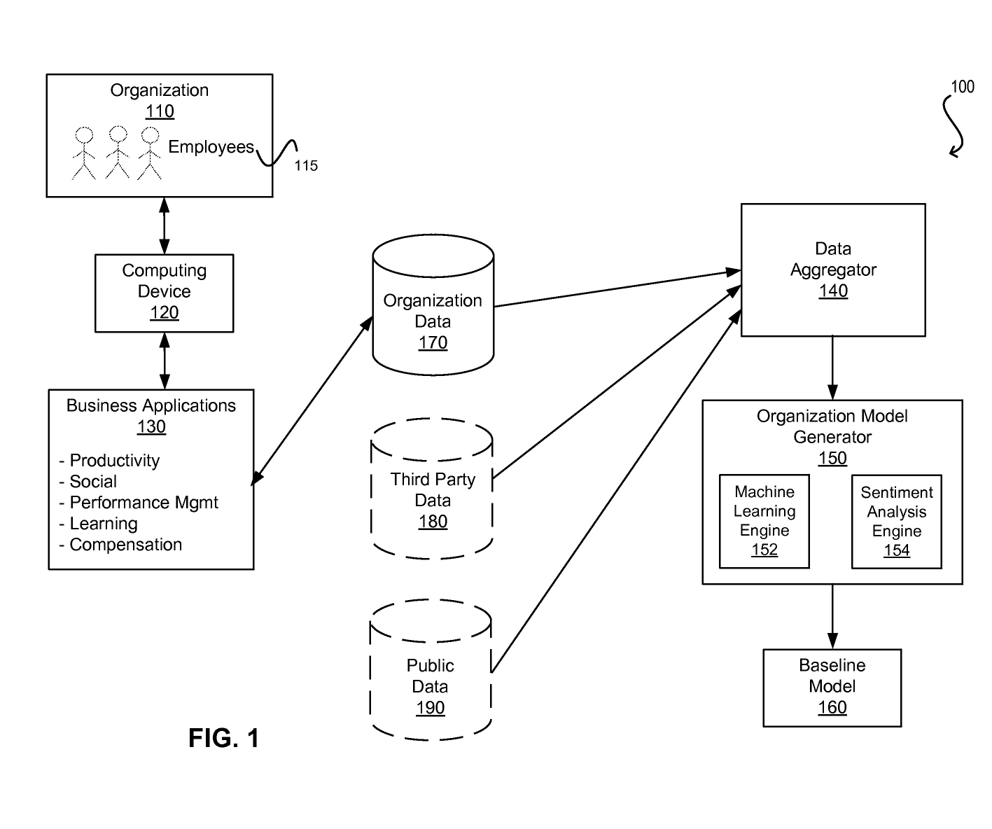

FIG. 1 illustrates system 100 according to one embodiment. System 100 includes organization 110 which includes employees 115. Employees 115 can represent the employees of the organization that belong in various departments, such as human resources, engineering, sales, management, etc. Employees 115 can use computing device 120 to access business applications 130 for performing daily tasks relevant to their role in the company. For example, engineers may use productivity applications to track the progress of current projects. Employees from different groups may use social applications to share ideas and opinions. Managers may use performance management applications to review the performance of their subordinates within organization 110. Learning applications can be used to educate employees on products and/or services offered by organization 110. Compensation applications can be used by human resources to track and modify the compensation of employees within organization 110.

Employee data is constantly being generated as employees 115 use business applications 130. The employee data can include data related to employee compensation. For example, employee data can include employee pay raises, employee stock options, and employee commissions to name a few. Employee data can also include data related to employee performance. For example, employee data can include employee promotions, performance management ratings, 360 reviews, employee expertise, employee resumes, employee goals, employee generated documents, and discussion of the employee in social network applications utilized by the organization to name a few.

In some examples, employee data can include structured and unstructured data. Structured data is data that resides in a fixed field within a record of a database, such as a traditional row-column database. In contrast, unstructured data is data cannot be stored a structured field in the database. Examples of unstructured data include a block of text or multimedia content such as email messages, word processing documents, videos, photos, audio files, presentations, web pages, etc. or comments/notes sections of employee reviews. Unstructured data can is processed and analyzed to create structured data which can in turn be stored in a database. Typically, employee data generated from business applications 130 can be stored in multiple databases. For instance, a first database can store data generated from a productivity application while a second database stores data generated from a compensation application. For simplicity, the employee data is shown here as stored in a single database, organization data 170.

System 100 further includes data aggregator 140. Data aggregator 140 is configured to aggregate data from one or more data sources and present the aggregated data to organization model generator 150. Here, data aggregator 140 can aggregate employee data from organization data 170 and optionally third party data 180 and/or public data 190. Third party data 180 can be data that is available to system 100 from a third party other than the organization. This can include employee data from other organizations. Public data 190 can be employee data that is publically available, either from the Internet or public organizations, other publicly available sources. In one embodiment, data aggregator 140 can aggregate employee data from multiple sources. This can allow organization model generator 150 to generate a baseline model 160 which factors in conditions from the current environment (which are provided from sources other than organization data 170). For example, the compensation offered by organization 110 and the compensation offered by competitors can be factored during the generation of baseline model 160. This can result in a more precise baseline model 160 since baseline model 160 is taking into consideration a greater amount of data.

System 100 further includes organization model generator 150. Organization model generator 150 is configured to generate baseline model 160 from the aggregated data received from data aggregator 140. Baseline model 160 is a model which is used to evaluate the likelihood that an employee is going to leave the organization according to one or more churn metrics. A churn metric is a factor that is considered important in determining whether an employee will leave the organization. Exemplary churn metrics are performance rating, bonus, and raise. Depending on the data that has been aggregated, baseline model 160 can be based on solely employee data from organization 110 or a combination of employee data from organization 110 and other data sources. As shown, organization model generator 150 includes machine learning engine 152 and sentiment analysis engine 154. Machine learning engine 152 and sentiment analysis engine 154 can perform predictive analysis on the aggregated employee data to estimate how an employee's sentiment towards the organization changes in response to a churn metric (e.g., performance rating, bonus, raise, etc).

Machine learning engine 152 is configured to work on a set of variables to generate a predicted outcome. The data provided as input to machine learning engine 152 contains values for the identified variables. In one embodiment, machine learning engine 152 can process structured employee data that is associated with a churn metric and generate a baseline for the churn metric. In one example, the structured employee data can be clustered into groups according to roles in the organization and baseline for the churn metric can be generated per role.

Sentiment analysis engine 154 contains an ontology that identifies the positive and negative terms in unstructured data. Terms in the ontology can be refined on an ongoing basis. In one embodiment, sentiment analysis engine 154 can process unstructured employee data that is associated with a churn metric and generate a baseline for the churn metric. In other examples, structured employee data associated with an employee metric is processed by machine learning engine 152 and unstructured employee data associated with the same employee metric is processed by sentiment analysis engine 154. Organization model generator 150 can combine the processed data from machine learning engine 152 and sentiment analysis engine 154 to create the baseline for the employee metric. For instance, a performance review document can include structured fields and a comments section. The structured fields can be processed by machine learning engine 152 while the comments section is processed by sentiment analysis engine 154. The results can be combined to create the baseline for employee performance.

In some embodiments, organization model generator 150 can periodically update baseline model 160. For example, organization model generator 150 can be configured to update baseline model 160 as new data is available in one or more data sources. In one embodiment, organization model generator 150 can be configured to update baseline model 160 according to a predefined schedule or time interval. In another embodiment, organization model generator 150 can receive a signal from data aggregator 140 that a batch of new data is available. When the signal is received, organization model generator 150 can update the baseline model 160 using the newly available data.

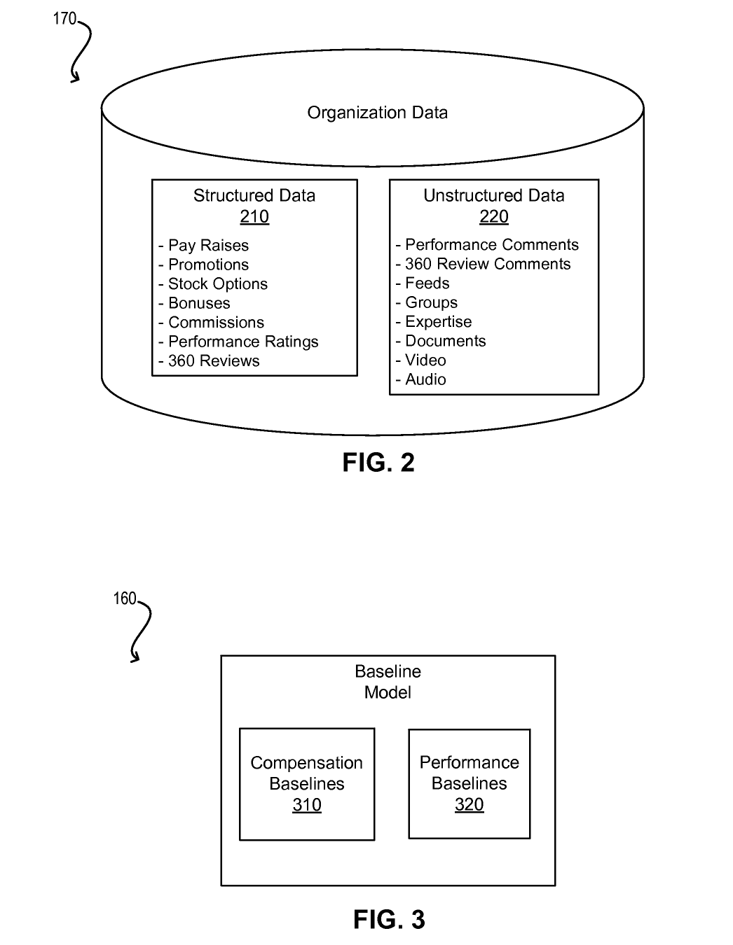

FIG. 2 illustrates organization data 170 according to one embodiment. As shown here, organization data 170 includes structured data 210 and unstructured data 220. Structured data 210 is data that resides in a fixed field within a record of a database, such as a traditional row-column database. Here, structured data 210 includes pay raises, promotions, stock options, bonuses, commissions, performance ratings, and 360 reviews. In contrast, unstructured data is data that does not fit neatly in a database. It can be a block of text or multimedia content such as email messages, word processing documents, videos, photos, audio files, presentations, web pages, etc. Here, unstructured data 220 includes performance comments, 360 review comments, news feeds, groups, expertise, documents, audio, and video. In one embodiment, unstructured data 220 can be processed and analyzed to generate structured data which can in turn be stored in a database. For example, 360 review comments in unstructured data 220 can be processed and factored into 360 reviews in structured data 210.

In one embodiment, organization data can also include structured and unstructured data of employees that have left the organization. Data of departed employees can provide valuable information to predict the factors which result in employee churn. By comparing the data of long term employees against the data of departed employees, organization model generator 150 can determine the churn metrics which affect employee sentiment. These churn metrics can be represented in baseline model 160 through the use of various baselines.

FIG. 3 illustrates baseline model 160 according to one embodiment. Baseline model 160 stores multiple baselines, which include compensation baselines 310 and performance baselines 320. Each baseline can be related to a churn metric. In one embodiment, a baseline is a table associated a value for the churn metric to a churn value. The churn value is a number that represents the employee's predicted sentiment when given the value for the churn metric. For example, the table can state that a performance rating of 3 where the highest mark is 4 is associated with a churn value of 30. The same table can state that a performance rating of 2 is associated with a churn value of 20. Thus, the higher the churn value the more content the employee is.

Compensation baselines 310 are baselines that are related to employee compensation. This can include the raise amount, base salary, stock options, commissions, bonuses, etc. In contrast, performance baselines 320 are baselines that are related to employee performance. This can include a role in the organization, job title, responsibilities, tasks performed, quality of performance, etc. In some embodiments, baseline model 160 can be periodically updated to remain current. In other embodiments, a baseline can be stored for each role at the company. For example, an employee performance baseline can exist in the baseline model for each employee role in the company. Given the employee's role in the company, the corresponding performance baseline can be applied.

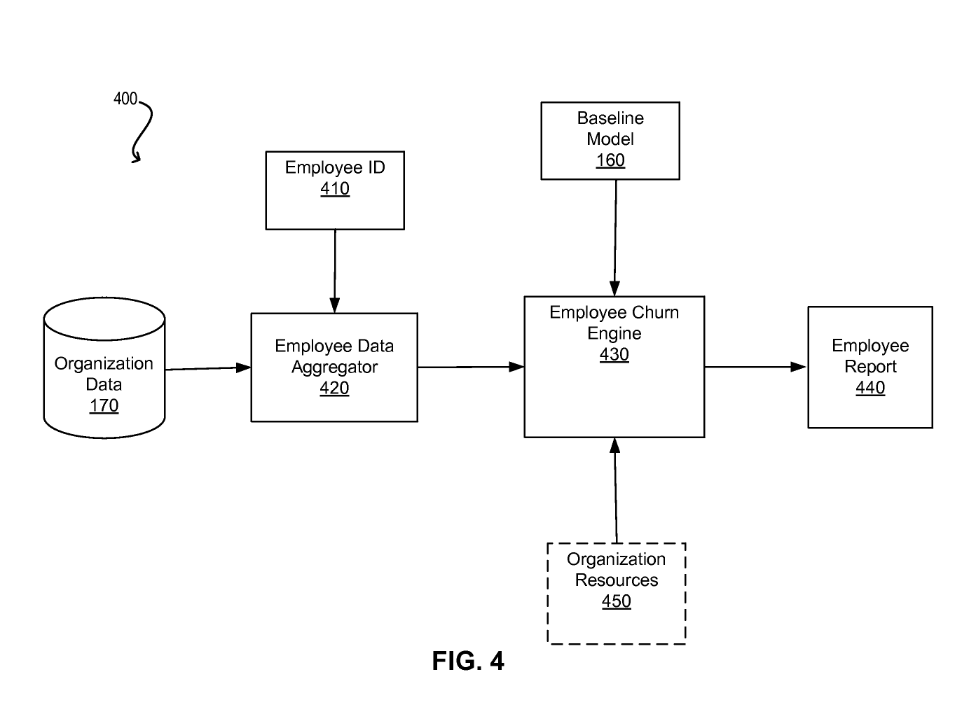

Once baseline model 160 has been generated, employee churn analysis can be performed. FIG. 4 illustrates system 400 for analyzing employee churn according to one embodiment. System 400 includes employee data aggregator 420 and employee churn engine 430. Employee data aggregator 420 is configured to aggregate employee data for an employee or for a group of employees based on an employee ID 410 and to generate employee values that correspond to churn metrics from the aggregated employee data. The generated employee values can represent the employee in employee churn engine 430. Employee ID 410 can be an identifier that uniquely identifies an employee in the organization. Using employee ID 410, employee metrics generator 420 can retrieve employee data from organization data 170 that is relevant to employee ID 410. In one embodiment, structured and unstructured data on employee ID 410 can be retrieved from organization data 170.

In one embodiment, employee data aggregator 420 can employ the same or similar techniques and algorithms as organization model generator 150 to generate the employee values. While organization model generator 150 is generating baselines for churn metrics that summarize and describe a group of employees within the organization, employee data aggregator 420 is generating employee values for churn metrics that summarize and describe a particular employee. The churn metrics can be based on data accumulated over a period of time. This data can be similar across an organization or could be specific to a department or group in the organization. Historical patterns of the data can be analyzed.

Employee churn engine 430 can receive employee values generated by employee data aggregator 420. Employee churn engine 430 is configured to analyze the employee values to generate an employee churn score that describes the employee's satisfaction working for the organization. In one embodiment, employee churn engine 430 can analyze the employee values by using baseline model 160 to interpret the employee values. Each employee value can be analyzed using a baseline that corresponds to the same churn metric (and optionally the same employee role). In one embodiment, employee churn engine 430 can assign a churn value for each employee value. For example, employee churn engine 420 can examine an employee value for the employee metric pay raise by using a pay raise baseline and predict that according to the employee's most recent pay raise (or history of pay raises), the employee has a churn score of 75 for the churn metric of pay raise. This process can be repeated for each employee value. The churn values can be consolidated to generate the employee churn score.

In one embodiment, employee churn engine 430 can compare the employee churn score with a predefined threshold to determine the likelihood of this particular employee leaving the organization. If the employee churn score is within a first range (or below a first threshold), employee churn engine 430 can determine that the employee most likely will leave the organization. If the employee churn score is within a second range (or below a second threshold), employee churn engine 430 can determine that the employee may possibly leave the organization. If the employee churn score is within a third range (or above a third threshold), employee churn engine 430 can determine that the employee most likely will stay with the organization. In other embodiments, the employee churn score can be evaluated using other means to determine the likelihood of the employee leaving the organization.

In some embodiments, employee churn engine 430 can also provide recommended actions for employee's having a low employee churn score. Employee churn engine 430 can analyze organization resources 450 to determine whether there are available resources (such as money, projects, and other resources) which, if provided to the employee, can improve the employee churn score. If the employee churn score is sufficiently improved, the employee can transition from one category to another. For instance, the employee can change from being likely to leave the organization to being likely to stay with the organization. In one embodiment, employee churn engine 430 can attempt to match low employee values with available organization resources 450.

In some embodiments, system 400 can be configured to parallel process multiple employees. The employees can all belong to a group or department in the organization. By processing all the employees in a group or department together, organizational resources assigned to the group or department can be best utilized to retain the highest performing employees. For example, employee ID 410 can pass a string of employee IDs to employee metrics generator 420 to generate a set of employee values for each employee. Employee churn engine 430 can analyze each set of employee values and generate an employee churn score for each employee. The employee churn scores can identify which employees are likely to stay and leave the organization. In one embodiment, employee churn engine 430 can continue by ranking the employees based on their performance based employee values to determine which employees in the group or department are the highest performing employees and order them by rank. Once the employees are ordered according to their ranking, employee churn engine 430 can assign the available resources based on the rankings. In one example, employee churn engine 430 can assign the resources in hopes of retaining the highest performing employees. In another example, employee churn engine 430 can assign the resources in hopes of retaining the greatest number of employees. The results of the employee churn analysis plus the recommendations to remediate the potential churn can be stored in employee report 440 to be presented to one or more employees of the organization.

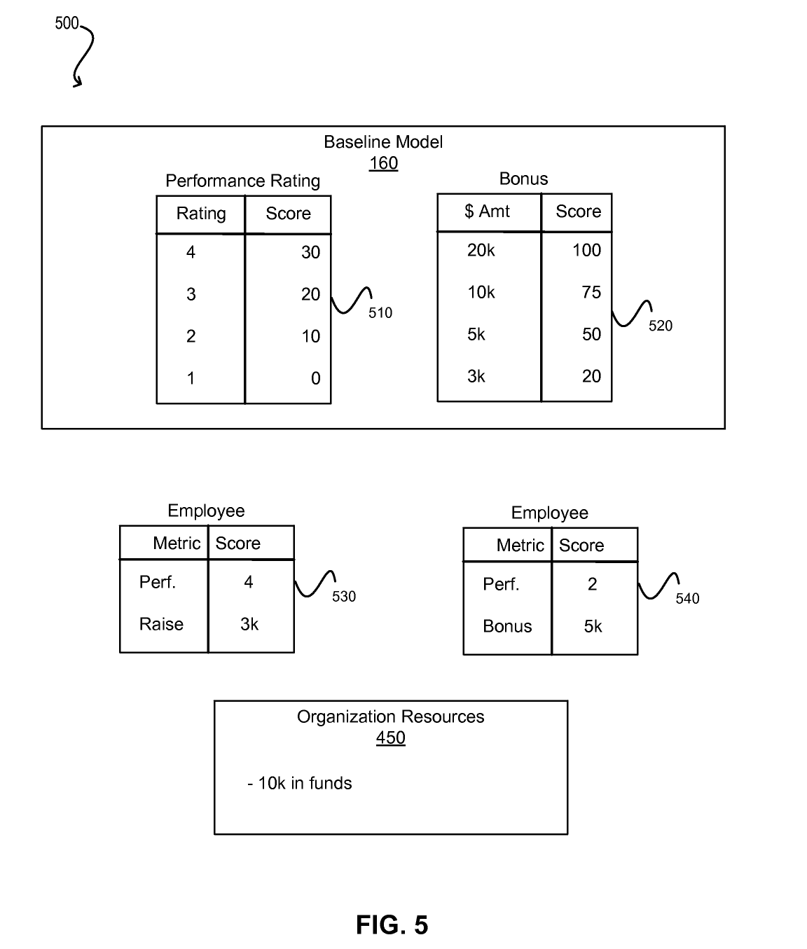

FIG. 5 illustrates a concrete example of a baseline, employee values, and organization resources. Here, baseline model 160 includes performance rating baseline 510 and bonus baseline 520. Performance rating baseline 510 evaluates the performance of the employee while bonus baseline 520 analyzes the most recent bonus amount provided to the employee. Each baseline can be generated by analyzing employee data from the organization and/or other data sources.

Employee data aggregator 420 has evaluated employee data to generate employee values for employee 530 and employee 540. Employee 530 has an employee value of 4 for the performance rating churn metric and an employee value of 3 k for the bonus churn metric. In contrast, employee 540 has an employee value of 2 for the performance rating churn metric and an employee value of 5 k for the bonus churn metric.

Employee churn engine 430 can analyze the employee values for employee 530 and employee 540 to generate an employee churn score. For employee 530, employee churn engine 430 can determine that a performance rating of 3 equates to a churn value of 20 and a bonus amount of 3 k equates to a churn score of 20. Adding the churn values together gives employee 530 an employee churn score of 40. A similar calculation can be performed for employee 540 to generate an employee churn score of 60. Assuming that it has been determined through analysis of employee data that an employee churn score under 75 means an employee is likely to leave the organization, employee churn engine 430 can determine that both employees are likely to leave the organization. Employee churn engine 430 can determine that there is 10 k in organization resources 450 which can be assigned to the employees to improve their employee churn score. Employee churn engine 430 can allot the 10 k in funds to employee 530 to improve his employee churn score above 75, thus improving the likelihood that employee 530 will stay with the organization. The logic to determine which employee to keep when there are insufficient organization resources to keep both can depend on the performance rating of the employees with the goal of retaining the highest performing employees.

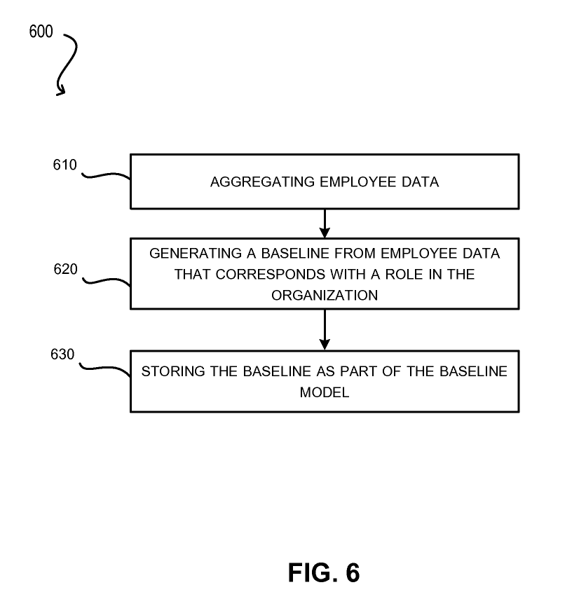

FIG. 6 illustrates a process flow for generating a baseline model according to one embodiment. Process 600 can be stored in computer readable medium and executed by a one or more processors, such as by data aggregator 140 and organization model generator 150 in FIG. 1. In some examples, data aggregator 140 and organization model generator 150 can be combined. Process 600 begins by aggregating employee data at 610. In one example, the employee data can be data generated by business applications such as enterprise applications provided by the organization to its employees. In another example, the employee data can be data generated by other organizations or data that is publically available. In yet other examples, the employee data can be from a combination of data courses. Once the data has been aggregated, process 600 continues by generating a baseline from employee data that corresponds with a role in the organization at 620. For example, employee data that corresponds with the role of a software engineer can be used to generate baselines for a software engineer. The baselines can include performance baselines and compensation baselines that are relevant to software engineers. Once the baseline has been generated, process 600 can continue by storing the baseline as part of the baseline model at 630.

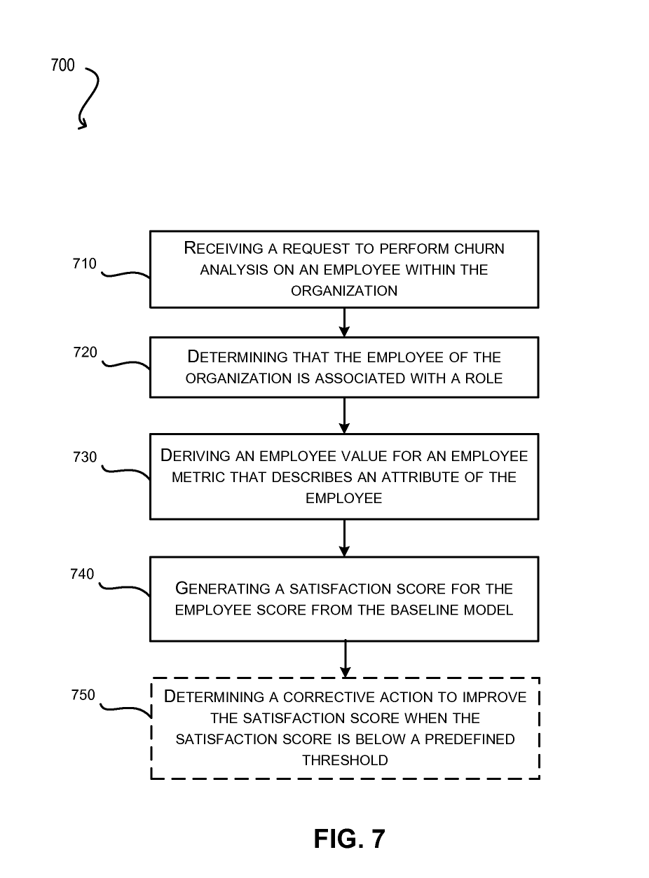

FIG. 7 illustrates a process flow for generating analyzing employee churn according to one embodiment. Process 700 can be stored in computer readable medium and executed by a one or more processors, such as by employee metrics generator 520 and employee churn engine 530 in FIG. 5. In some examples, employee metrics generator 520 and employee churn engine 530 can be combined. Process 700 begins by receiving a request to perform churn analysis on an employee within the organization at 710. In some examples, the request can include multiple employees or a group of employees. Once the request has been received, process 700 continues by determining that the employee of the organization is associated with a role. In one example, the role can be a software engineer. In another example, the role can be a sales associate. Once the role of the employee is determined, process 700 continues by deriving an employee value for an employee metric that describes an attribute of the employee at 730. The employee value can be derived by analyzing available employee data that corresponds with the requested employee. For example, employee data available in the organization about a particular sales associate can be analyzed to generate an employee value for the sales associate. The employee value can be for a given employee metric. In some examples, a set of employee values can be generated for the sales associate where each employee value is for a unique employee metric.

Once the employee score has been derived, process 700 continues by generating a satisfaction score for the employee score from the baseline model at 740. In one embodiment, the employee value can be evaluated according to a baseline from the baseline model. The baseline can be associated with the same employee metric as the employee value. In some examples, multiple satisfaction scores can be generated from multiple employee values. The satisfaction scores can be combined to form an overall satisfaction score. Once the satisfaction score is generated, process 700 can optionally determine a corrective action to improve the satisfaction score when the satisfaction score is below a predefined threshold at 750. In some examples, the corrective action can be dependent on the available resources of the organization. In some embodiments, the corrective action and the satisfaction score can be packaged in a report to be presented to one or more employees of the organization.

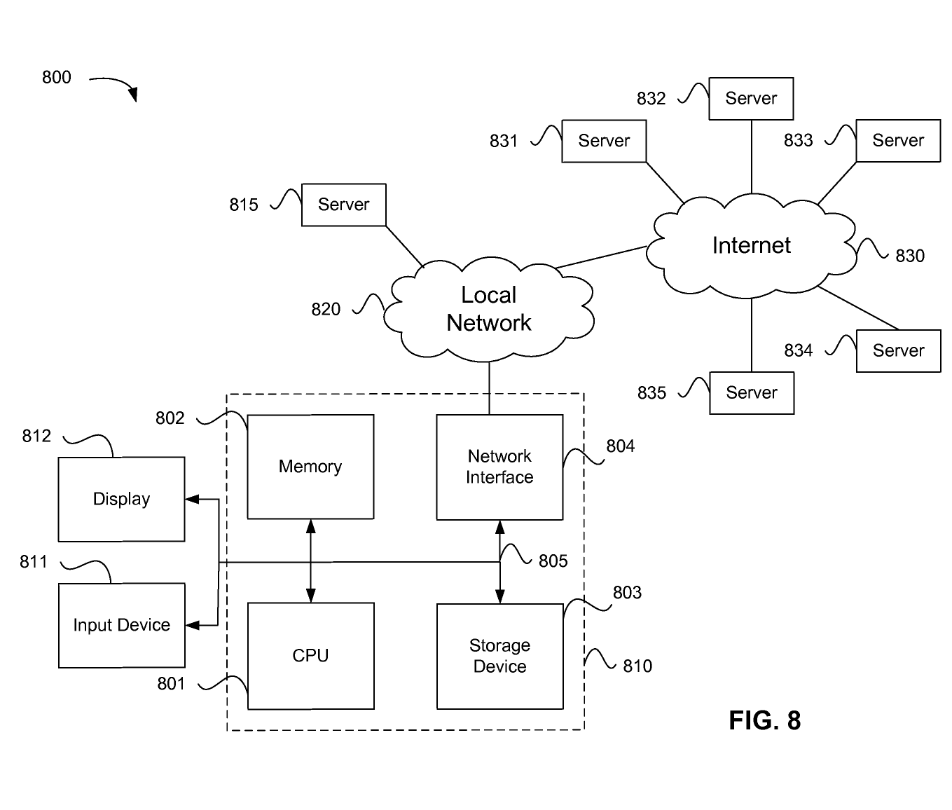

An exemplary computer system 800 is illustrated in FIG. 8. Computer system 810 includes bus 805 or other communication mechanism for communicating information, and a processor 801 coupled with bus 805 for processing information. Computer system 810 also includes a memory 802 coupled to bus 805 for storing information and instructions to be executed by processor 801, including information and instructions for performing the techniques described above, for example. This memory may also be used for storing variables or other intermediate information during execution of instructions to be executed by processor 801. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 803 may include source code, binary code, or software files for performing the techniques above, for example. Storage device and memory are both examples of computer readable mediums.

Computer system 810 may be coupled via bus 805 to a display 812, such as a cathode ray tube (CRT) or liquid crystal display (LCD), for displaying information to a computer user. An input device 811 such as a keyboard and/or mouse is coupled to bus 805 for communicating information and command selections from the user to processor 801. The combination of these components allows the user to communicate with the system. In some systems, bus 805 may be divided into multiple specialized buses.

Computer system 810 also includes a network interface 804 coupled with bus 805. Network interface 804 may provide two-way data communication between computer system 810 and the local network 820. The network interface 804 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 804 sends and receives electrical, electromagnetic, or optical signals that carry digital data streams representing various types of information.

Computer system 810 can send and receive information, including messages or other interface actions, through the network interface 804 across a local network 820, an Intranet, or the Internet 830. For a local network, computer system 810 may communicate with a plurality of other computer machines, such as server 815. Accordingly, computer system 810 and server computer systems represented by server 815 may form a cloud computing network, which may be programmed with processes described herein. In the Internet example, software components or services may reside on multiple different computer systems 810 or servers 831-835 across the network. The processes described above may be implemented on one or more servers, for example. A server 831 may transmit actions or messages from one component, through Internet 830, local network 820, and network interface 804 to a component on computer system 810. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method, comprising:
receiving, by a processor, a request to perform churn analysis on an employee within the organization;
determining, by the processor, that the employee of the organization is associated with a role in the organization;
deriving, by the processor, an employee value from employee data generated by a plurality of enterprise applications utilized by the organization, the employee value being for an employee metric that describes an attribute of the employee; and
generating, by the processor, a satisfaction score for the employee from a baseline model corresponding to the organization and the employee value, wherein the baseline model includes a baseline corresponding to the employee metric and the role in the organization.

2. The computer-implemented method of claim 1, further comprising:
aggregating, by the processor, the employee data that is associated with employees of the organization;
generating, by the processor, the baseline from employee data that corresponds with the role in the organization; and
storing, by the processor, the baseline as part of the baseline model.

3. The computer-implemented method of claim 2, wherein the employee data includes structured data and generating the baseline comprises performing, by the processor, machine learning on the structured data.

4. The computer-implemented method of claim 2, wherein employee data includes unstructured data and generating the baseline comprises performing, by the processor, sentiment analysis on the unstructured data.

5. The computer-implemented method of claim 1, wherein the baseline model is based on historical data associated with the organization.

6. The computer-implemented method of claim 1, wherein the baseline model is based on employee data associated with another organization.

7. The computer-implemented method of claim 1, further comprising determining, by the processor, a corrective action to improve the satisfaction score when the satisfaction score is below a predefined threshold.

8. A non-transitory computer readable storage medium storing one or more programs, the one or more programs comprising instructions for:
receiving a request to perform churn analysis on an employee within the organization;
determining that the employee of the organization is associated with a role in the organization;
deriving an employee value from employee data generated by a plurality of enterprise applications utilized by the organization, the employee value being for an employee metric that describes an attribute of the employee; and
generating a satisfaction score for the employee from a baseline model corresponding to the organization and the employee value, wherein the baseline model includes a baseline corresponding to the employee metric and the role in the organization.

9. The non-transitory computer readable storage medium of claim 8, further comprising:
aggregating the employee data that is associated with employees of the organization;
generating the baseline from employee data that corresponds with the role in the organization; and
storing the baseline as part of the baseline model.

10. The non-transitory computer readable storage medium of claim 9, wherein the employee data includes structured data and generating the baseline comprises performing, by the processor, machine learning on the structured data.

11. The non-transitory computer readable storage medium of claim 9, wherein employee data includes unstructured data and generating the baseline comprises performing, by the processor, sentiment analysis on the unstructured data.

12. The non-transitory computer readable storage medium of claim 8, wherein the baseline model is based on historical data associated with the organization.

13. The non-transitory computer readable storage medium of claim 8, wherein the baseline model is based on employee data associated with another organization.

14. The non-transitory computer readable storage medium of claim 8, further comprising determining, by the processor, a corrective action to improve the satisfaction score when the satisfaction score is below a predefined threshold.

15. A computer implemented system, comprising:
one or more computer processors; and
a non-transitory computer-readable storage medium comprising instructions, that when executed, control the one or more computer processors to be configured for:
receiving a request to perform churn analysis on an employee within the organization;
determining that the employee of the organization is associated with a role in the organization;
deriving an employee value from employee data generated by a plurality of enterprise applications utilized by the organization, the employee value being for an employee metric that describes an attribute of the employee; and
generating a satisfaction score for the employee from a baseline model corresponding to the organization and the employee value, wherein the baseline model includes a baseline corresponding to the employee metric and the role in the organization.

16. The computer implemented system of claim 15, further comprising:
aggregating the employee data that is associated with employees of the organization;
generating the baseline from employee data that corresponds with the role in the organization; and
storing the baseline as part of the baseline model.

17. The computer implemented system of claim 16, wherein the employee data includes structured data and generating the baseline comprises performing, by the processor, machine learning on the structured data.

18. The computer implemented system of claim 16, wherein employee data includes unstructured data and generating the baseline comprises performing, by the processor, sentiment analysis on the unstructured data.

19. The computer implemented system of claim 15, wherein the baseline model is based on historical data associated with the organization.

20. The computer implemented system of claim 15, further comprising determining, by the processor, a corrective action to improve the satisfaction score when the satisfaction score is below a predefined threshold.
